(19) United States
(12) Patent Application Publication
(10) Pub. No.: US 2015/0116880 A1
(43) Pub. Date: Apr. 30, 2015

(54) INDUCTOR PROTECTION DEVICE

(71) Applicants: HON HAI PRECISION INDUSTRY CO., LTD., NEW TAIPEI (TW); HONG FU JIN PRECISION INDUSTRY (SHENZHEN) CO., LTD., SHENZHEN (CN)

(72) Inventors: XIN WANG, Shenzhen (CN); YUAN-XI CHEN, Shenzhen (CN)

(73) Assignees: HON HAI PRECISION INDUSTRY CO., LTD., NEW TAIPEI (TW); HONG FU JIN PRECISION INDUSTRY (SHENZHEN) CO., LTD., SHENZHEN (CN)

(21) Appl. No.: 14/188,636

(22) Filed: Feb. 24, 2014

(30) Foreign Application Priority Data
Oct. 31, 2013 (CN) 2013105283816

(51) Int. Cl. H02H 3/20; H02H 9/04

(52) U.S. Cl. CPC H02H 3/20; H02H 9/04
USPC 361/86

(57) ABSTRACT

An inductor protection device includes a single chip microcomputer (SCM) and an input unit. The protection device is used for protecting an inductor in a circuit, the circuit includes a controller configured for triggering on or cutting off the circuit. The SCM sets a limiting voltage according to parameters input from the input unit, obtains a current voltage of the inductor, compares the current voltage with the limiting voltage, and sends a control signal to the controller to cut off the circuit when the current voltage is bigger than or equal to the limiting voltage.

### BACKGROUND

1. Technical Field

The present disclosure relates to an inductor protection device.

2. Description of Related Art

A conventional over-current protection circuit usually only protects a load in a circuit, and does not protect a inductor in the circuit. Thus, the inductor can be damaged when the current is bigger than a saturation current of the inductor.

Therefore, it is desirable to provide an inductor protection device which can overcome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a functional block of inductor protection device according to a exemplary embodiment of the present disclosure.

FIGS. 2 and 3 are circuit diagrams of the inductor protection device of FIG. 1.

### DETAILED DESCRIPTION

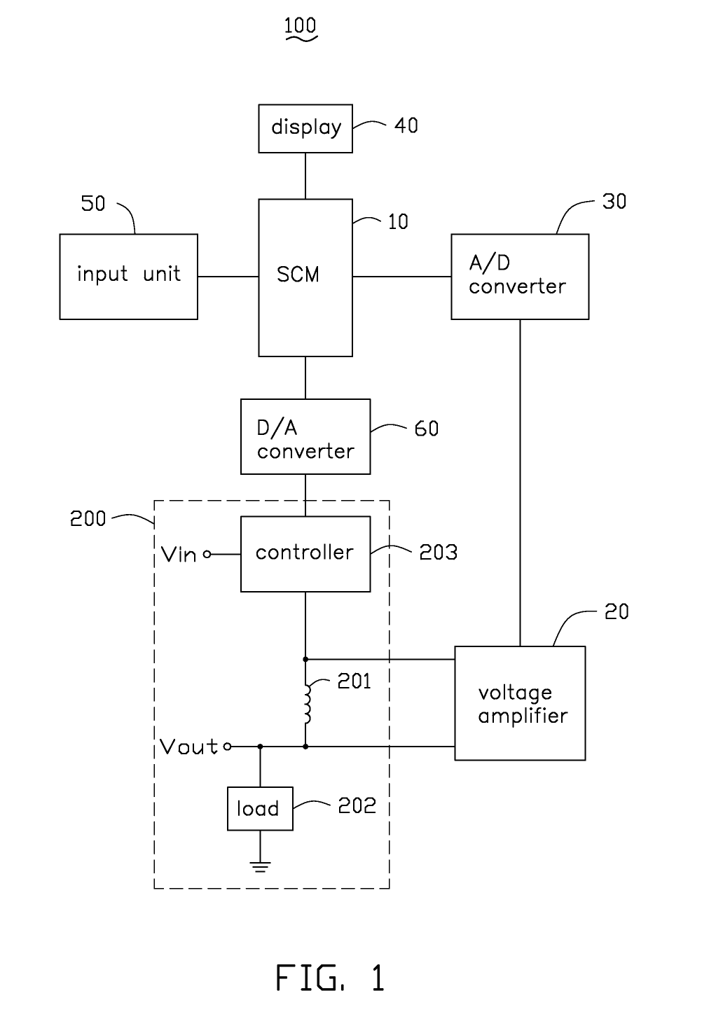

FIG. 1 shows an inductor protection device 100 according to an exemplary embodiment of the present disclosure. The inductor protection device 100 is used to protect an inductor 201 of a circuit 200. The circuit 200 further includes a load 202 and a controller 203. The controller 203 is configured for triggering on or off the circuit 200. In this embodiment, the circuit 200 is a power supply circuit. One end of the controller 203 is electrically connected to a voltage input end Vin, the other end of the controller 203 is electrically connected to a voltage output end Vout through the inductor 201. One end of the load 202 is electrically connected to the voltage output end Vout, the other end of the load 202 is grounded.

The inductor protection device 100 includes a single chip microcomputer (SCM) 10, a voltage amplifier 20, an analog/digital converter (A/D converter) 30, a display 40, an input unit 50 and a digital/analog converter (D/A converter) 60.

The SCM 10 is electrically connected to the A/D converter 30, the display 40, the input unit 50 and the D/A converter 60. In this embodiment, the SCM 10 is PIC16F73.

The voltage amplifier 20 is electrically connected to two ends of the inductor 201, and is configured for sensing a current voltage drop between two ends of the inductor 201 and amplifying the current voltage drop to obtain a current voltage. As a direct current resistor (DCR) of the inductor 201 is very small (such as several milliohms), when a current flowing through the inductor 201 is several tens amperes, the current voltage drop is only several hundreds millivolt. Thus, the voltage amplifier 20 is needed to amplify the current voltage drop. In this embodiment, the voltage amplifier 20 is a triode. An amplifying gain of the voltage amplifier 20 is 50 to 100 times, and the current voltage may be several volts.

The A/D converter 30 converts the current voltage from an analogy form into a digital form, and sends the current voltage in the digital form to the SCM 10. In this embodiment, the A/D converter 30 is LTC240X.

The input unit 50 is configured for inputting a saturation current of the inductor 201, a DCR of the inductor 201, a predetermined ratio, and amplifying times of the voltage amplifier 20. The predetermined ratio is used to increase a security factor of the inductor protective device 100 and a user can set the predetermined ratio as needed, such as 90%, 80%, and so on. In this embodiment, the input unit 50 is a keypad and includes a plurality of keys 51.

The input unit 50 is electrically connected to the SCM 10 and is configured for sending the above mentioned parameters to the SCM 10. The SCM 10 multiplies the parameters to obtain a limiting voltage of the inductor 201 according to the following formula: the limiting voltage equals the saturation current multiplied by the DCM multiplied by the predetermined ratio multiplied by the amplifying times.

The SCM 10 is further configured for comparing the current voltage with the limiting voltage to determine whether a current flowing through the inductor 201 is excessive, and sending a control signal to the D/A converter 60 according to the determining result. The D/A converter 60 converts the control signal from a digital form into an analogy form. The SCM 10 is further configured for control the display 40 to display according to the comparing result. In this embodiment, the display 40 is SMSO401, the D/A converter 60 is LTC420X.

In detail, the SCM 10 stores a warning voltage smaller than the limiting voltage. In the embodiment, the warning voltage is 95% of the limiting voltage. When the current voltage is smaller than the warning voltage, the SCM 10 controls the display 40 to display the current voltage. When the current voltage is bigger than or equal to the warning voltage and is smaller than the limiting voltage, the SCM 10 controls the display to display a warning signal (such as a word of “warning”). When the current voltage is bigger than or equal to the limiting voltage, the SCM 10 sends a control signal to the controller 203 through the D/A converter 60, the controller 203 cuts off the circuit 200 according to the control signal to protect the inductor 201 from overcurrent. The SCM 10 also controls the display 40 to display a reminder signal (such as a word of “protection”) to remind the user that the circuit 200 is cut off at this time.

In other embodiments, the limiting voltage can be directly input from the input unit 50.

In other embodiments, other warning devices, such as a speaker or a light emitting diode, can be used instead of the display 40 for the warning and reminder function.

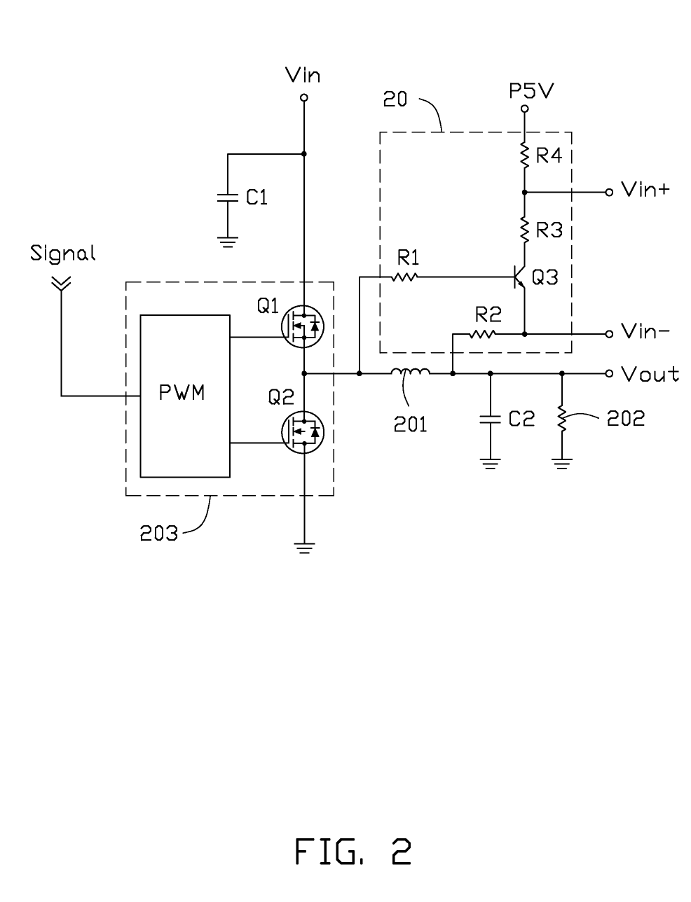

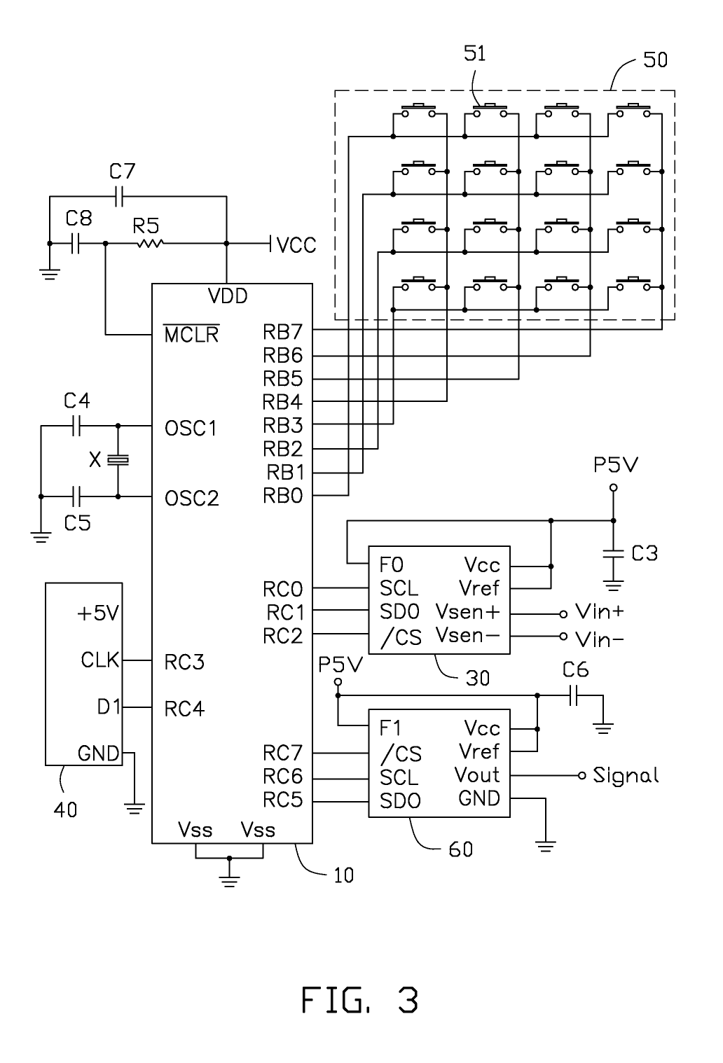

FIGS. 2 and 3 show circuit diagrams of the inductor protection device 100. The controller 203 includes a pulse width modulator (PWM), a first field-effect transistor (FET) Q1 and a second FET Q2. The voltage amplifier 20 includes a triode Q3 and resistors R1, R2, R3 and R4. The resistors R1, R2, R3, and R4 are used to adjust the amplifying times of the voltage amplifier 20. An input end of the PWM is electrically connected to the D/A converter 60. Two output ends of the PWM are respectively electrically connected to grids of the first FET Q1 and second FET Q2. A source of the first FET Q1 is electrically connected to a drain of the second FET Q2. A drain of the first FET Q1 is electrically connected to the voltage input end Vin and a first capacitor C1. The first capacitor C1 in turn is grounded. A source of the second FET Q2 is grounded. A first end of the inductor 201 is electrically connected to the source of the first FET Q1 and the resistor R1. The resistor R1 is in turn electrically connected to a base of the triode Q3. A second end of the inductor 201 is electrically connected to the resistor R2. The resistor R2 is in turn electrically connected to an emitter of the triode Q3. The second end of the inductor 201 is also electrically connected to a capacitor C2 and the load 202. The capacitor C2 and the load 202 are in turn grounded. Thus, a circuit is formed between the capacitor C2 and the load 202. When there is no voltage input from the voltage input end Vin, the capacitor C2 supplies power to the load 202. The second end of the inductor 201 is electrically connected to the voltage output end Vout to make sure the voltage output end Vout can supply power to the load 202. A collector of the triode Q3 is electrically connected to the resistors R3, R4 and a voltage source P5V in series. A first voltage collecting terminal of the triode Q3 is connected between the resistors R3 and R4, a second voltage collecting terminal of the triode Q3 is connected to the emitter of the triode Q3. When the D/A converter 60 sends the control signal to the PWM, the PWM cuts off the first and second FETS Q1 and Q2 to make sure no current can flow through the inductor 201 to protect the inductor 201.

A first input terminal Vsen+ of the A/D converter 30 is electrically connected to the first voltage connecting terminal Vin+, a second input terminal Vsen− of the A/D converter 30 is electrically connected to the second voltage connecting terminal Vin−, a chip select terminal/CS of the A/D converter 30 is electrically connected to a first chip select control terminal RC2 of the SCM 10, a digital terminal SD0 of the A/D converter 30 is electrically connected to a digital input terminal RC1 of the SCM 10, a clock signal terminal SCL of the A/D converter 30 is electrically connected to a first clock control terminal RC0 of the SCM 10. A voltage terminal Vcc, a reference voltage terminal Vref and a F0 terminal of the A/D converter 30 are all electrically connected to the voltage source P5V, and all grounded through a capacitor C3.

A chip select terminal/CS of the D/A converter 60 is electrically connected to a second chip select control terminal RC7 of the SCM 10, a clock signal terminal SCL of the D/A converter 60 is electrically connected to a second clock control terminal RC6 of the SCM 10, a digital terminal SD0 of the D/A converter 60 is electrically connected to a digital output terminal RC5 of the SCM 10. A signal output terminal Vout of the D/A converter 60 is electrically connected to the input end of the PWM. A voltage terminal Vcc, a reference voltage terminal Vref and a F1 terminal of the D/A converter 60 are all electrical connected to the voltage source P5V, and all grounded through capacitor C6. A ground terminal GND of the D/A converter 60 is grounded.

A clock signal terminal CLK of the display 40 is electrically connected to a display clock control terminal RC3 of the SCM 10, a digital terminal D1 of the display 40 is electrically connected to a display digital terminal RC4 of the SCM 10. A voltage input terminal VDD of the display 40 is electrically connected to an external power supply. A ground terminal GND of the display 40 is grounded.

The keys 51 of the input unit 50 is electrically connected to keypad control terminals RB0, RB1, RB2, RB3, RB4, RB5, RB6, and RB7 of the SCM 10.

An oscillation input terminal OSC1 of the SCM 10 is electrically connected to a first end of a crystal oscillator X, an oscillation output terminal OSC2 of the SCM 10 is electrically connected to a second end of the crystal oscillator X. The first end of the crystal oscillator X is further grounded through capacitor C4. The second end of the crystal oscillator X is further grounded through capacitor C5.

The voltage input terminal VDD of the SCM is electrically connected to a power supply VCC, and is grounded through capacitor C7. A M̅C̅L̅R̅ terminal of the SCM 10 is electrically connected to the power supply VCC, and is grounded through capacitor C8. Two ground terminals Vss of the SCM 10 are grounded.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. An inductor protection device for protecting an inductor in a circuit, the circuit comprising a controller configured for trigger on or cut off the circuit, the device comprising:
a single chip microcomputer (SCM); and
an input unit; wherein
the SCM sets a limiting voltage according to parameters inputted from the input unit, obtains a current voltage of the inductor, compares the current voltage with the limiting voltage, and sends a control signal to the controller to cut off the circuit when the current voltage is bigger than or equal to the limiting voltage.

2. The device of claim 1, further comprising a voltage amplifier electrically connected to the SCM, the voltage amplifier sensing a current voltage drop between two ends of the inductor, and amplifying the current voltage drop to obtain the current voltage.

3. The device of claim 2, wherein the input unit is configured for inputting a saturation current of the inductor, a direct current resistor (DCR) of the inductor, a predetermined ratio and an amplifying times of the voltage amplifier, the SCM multiplies the saturation current of the inductor, the DCR of the inductor, the predetermined ratio and the amplifying times of the voltage amplifier to obtain the limiting voltage.

4. The device of claim 1, further comprising an analog/digital converter (A/D converter)and a digital/analog converter (D/A converter), the A/D converter being electrically connected to the SCM and converting the current voltage from an analog form into a digital form and sending the current voltage in the digital form to the SCM, the D/A converter being electrically connected to the SCM and the controller and converts the control signal form a digital form into an analog form and sending the control signal in the analog form to the controller.

5. The device of claim 4, wherein the A/D converter comprises a first input terminal and a second input terminal for cooperatively receiving the current voltage, a chip select terminal, a digital terminal, and a clock signal terminal, the SCM comprises a first chip select control terminal electrically connected to the chip select terminal, a digital input terminal electrical connected to the digital terminal, and a first clock control terminal electrically connected to the clock signal terminal.

6. The device of claim 4, wherein the D/A converter comprises a chip select terminal, a clock signal terminal, a digital terminal, and a signal output terminal, the SCM comprises a second chip select control terminal electrically connected to the chip select terminal, a second clock control terminal electrically connected to the clock signal terminal, and a digital output terminal electrically connected to the digital terminal, the controller comprises an input end electrical connected to the signal output terminal.

7. The device of claim 1, further comprising a display electrically connected to the SCM, wherein when the current voltage is bigger than or equal to the limiting voltage, the SCM controls the display displaying a reminder signal.

8. The device of claim 7, wherein the SCM stores a warning voltage smaller than the limiting voltage, when the current voltage is smaller than the warning voltage, the SCM controls the display displaying the current voltage, when the current voltage is bigger than or equal to the warning voltage and is smaller than the limiting voltage, the SCM controls the display displaying a warning signal.

9. The device of claim 8, wherein the display comprises a clock signal terminal and a digital terminal, the SCM comprises a display clock control terminal electrically connected to the clock signal terminal, and a display digital terminal electrically connected to the digital terminal.
